(19) United States
(12) Patent Application Publication
(10) Pub. No.: US 2026/0236829 A1
(43) Pub. Date: Aug. 13, 2026

(54) MACHINE LEARNING FEATURE RECOMMENDATION

(71) Applicant: ServiceNow, Inc., Santa Clara, CA (US)

(72) Inventors: Seganrasan Subramanian, Hyderabad (IN); Baskar Jayaraman, Fremont, CA (US); Ranga Prasad Chenna, Hyderabad (IN)

(21) Appl. No.: 19/051,872

(22) Filed: Feb. 12, 2025

Related U.S. Application Data
(63) Continuation of application No. 17/330,073, filed on May 25, 2021, now abandoned.
Application No. 17/330,073 is a continuation-in-part of application No. 16/931,906, filed on Jul. 17, 2020, now abandoned.

(51) Int. Cl. G06N 20/00

(52) U.S. Cl. CPC G06N 20/00

(57) ABSTRACT

A pre-trained model trained to predict a measure of expected model performance based at least in part on a feature relevance score associated with a text field data type is generated. A specification of a desired target field for machine learning prediction and one or more text fields storing input content is received. A corresponding feature relevance score for each of the one or more text fields storing the input content is calculated. Based on the corresponding calculated feature relevance scores, a corresponding measure of expected model performance for each of the one or more text fields storing the input content is predicted using the pre-trained model. The predicted measures of expected model performance are provided for use in feature selection among the one or more text fields storing the input content for generating a machine learning model to predict the desired target field.

### CROSS REFERENCE TO OTHER APPLICATIONS

This application is a continuation of pending U.S. patent application Ser. No. 17/330,073, filed May 25, 2021, entitled MACHINE LEARNING FEATURE RECOMMENDATION, which is a continuation-in-part of U.S. patent application Ser. No. 16/931,906, filed Jul. 17, 2020, entitled MACHINE LEARNING FEATURE RECOMMENDATION, both of which are hereby incorporated by reference in their entirety for all purposes.

### BACKGROUND OF THE INVENTION

The use of automatic classification using machine learning can significantly reduce manual work and errors when compared to manual classification. One method of performing automatic classification involves using machine learning to predict a category for input data. For example, using machine learning, incoming tasks, incidents, and cases can be automatically categorized and routed to an assigned party. Typically, automatic classification using machine learning requires training data which includes past experiences. Once trained, the machine learning model can be applied to new data to infer classification results. For example, newly reported incidents can be automatically classified, assigned, and routed to a responsible party. However, creating an accurate machine learning model is a significant investment and can be a difficult and time-consuming task that typically requires subject matter expertise. For example, selecting the input features that result in an accurate model typically requires a deep understanding of the dataset and how a feature impacts prediction results.

### BRIEF DESCRIPTION OF THE DRAWINGS

Various embodiments of the invention are disclosed in the following detailed description and the accompanying drawings.

FIG. 1 is a block diagram illustrating an example of a network environment for creating and utilizing a machine learning model.

FIG. 2 is a flow chart illustrating an embodiment of a process for creating a machine learning solution.

FIG. 3 is a flow chart illustrating an embodiment of a process for automatically identifying recommended features for a machine learning model.

FIG. 4 is a flow chart illustrating an embodiment of a process for automatically identifying recommended features for a machine learning model.

FIG. 5 is a flow chart illustrating an embodiment of an evaluation process for automatically identifying recommended features for a machine learning model.

FIG. 6 is a flow chart illustrating an embodiment of a process for creating an offline model for determining a performance metric of a feature.

FIG. 7 is a flow chart illustrating an embodiment of a process for automatically identifying and evaluating text fields as potential features for a machine learning model.

FIG. 8 is a flow chart illustrating an embodiment of a process for evaluating the eligibility of a text field as a feature for a machine learning model to predict a desired target field.

FIG. 9 is a flow chart illustrating an embodiment of a process for preparing input text field data to determine an impact score.

FIG. 10 is a flow chart illustrating an embodiment of a process for determining a performance metric for a text field feature.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques for selecting machine learning features are disclosed. When constructing a machine learning model, feature selection can significantly influence the accuracy and usability of the model. However, it can be a challenge to appropriately select features that improve the accuracy of the model without subject matter expertise and a deep understanding of the machine learning problem. Using the disclosed techniques, machine learning features can be automatically recommended and selected that result in significant improvement in the prediction accuracy of a machine learning model. Moreover, little to no subject matter expertise is required. For example, a user with minimal understanding of an input dataset can successfully generate a machine learning model that can accurately predict a classification result. In some embodiments, a user can utilize the machine learning platform via a software service, such as a software-as-a-service web application.

In various embodiments, the user provides to the machine learning platform an input dataset, such as identifying one or more database tables. The provided dataset includes multiple eligible features. The eligible features can include features that are useful in accurately predicting a machine learning result as well as features that are useless or have minor impact on accurately predicting the machine learning result. Accurately identifying useful features can result in a highly accurate model and improve resource usage and performance. For example, training a model with useless features can be a significant resource drain that can be avoided by accurately identifying and ignoring useless features. In various embodiments, a user specifies a desired target field to predict and the machine learning platform using the disclosed techniques can generate a set of recommended machine learning features from the provided input dataset for use in building a machine learning model. In some embodiments, the recommended machine learning features are determined by applying a series of evaluations to the eligible features to filter useless features and to identify helpful features. Once the set of recommended features is determined, it can be presented to the user. For example, in some embodiments, the features are ranked in order of improvement to the prediction result. In some embodiments, a machine learning model is trained using the features selected by the user based on the recommendation features. For example, a model can be automatically trained using the recommended features that are automatically identified and ranked by improvement to the prediction result.

In some embodiments, a specification of a desired target field for machine learning prediction and one or more tables storing machine learning training data are received. For example, a customer of a software-as-a-service platform specifies one or more customer database tables. The tables can include data from past experiences, such as incoming tasks, incidents, and cases that have been classified. For example, the classification can include categorizing the type of task, incident, or case as well as assigning an appropriate party to be responsible for resolving the issue. In some embodiments, the machine learning data is stored in another appropriate data structure other than a database. In various embodiments, the desired target field is the classification result, which may be a column in one of the received tables. Since the received database table data has not necessarily been prepared as training data, the data can include both useful and useless fields for predicting the classification result. In some embodiments, eligible machine learning features for building a machine learning model to perform a prediction for the desired target field are identified within the one or more tables. For example, from the database data, fields are identified as potential or eligible features for training a machine learning model. In some embodiments, the eligible features be based on the columns of the tables. The eligible machine learning features are evaluated using a pipeline of different evaluations to successively filter out one or more of the eligible machine learning features to identify a set of recommended machine learning features among the eligible machine learning features. By successively filtering out features from the eligible features, features that have minor impact on model prediction accuracy are culled. The features that remain are recommended features that have predictive value. Each step of the filtering pipeline identifies additional features that are not helpful (and features that may be helpful). For example, in some embodiments, one filtering step removes features where the feature data is unnecessary or out-of-scope. Features that are sparsely populated in their respective database tables or where all the values of the feature are identical (e.g., is a constant) may be filtered out. In some embodiments, non-nominal columns are filtered out. In some embodiments, a filtering step calculates an impact score for each eligible feature. Features with an impact score below a certain threshold can be removed from recommendation. In some embodiments, a performance metric is evaluated for each eligible feature. For example, with respect to a particular feature, the increase in the model's area under the precision-recall curve (AUPRC) can be evaluated. In some embodiments, a model is trained offline to translate an impact score to a performance metric by evaluating feature selection for a large cross section of machine learning problems. The model can then be applied to the specific customer's machine learning problem to determine a performance metric that can be used to rank eligible features. Once identified, the set of recommended machine learning features are provided for use in building the machine learning model. For example, the customer can select from the recommended features and request a machine learning model be trained using the provided data and selected features. The model can then be incorporated into the customer's workflow to predict the desired target field. With little to no subject matter expertise, for example, in both the dataset as well as in machine learning, features can be automatically recommended (and selected) for a machine learning model that can be used to infer a target field.

In some embodiments, the eligible features include data that is text input data. For example, text input data can be text input that has a variable and/or arbitrary length such as user input gathered from an input text field, an email subject or body, a chat dialogue, etc. In various embodiments, among potentially other identified table data, one or more columns can include text input as a potential feature for predicting a desired target field. For example, a user specifies a desired target field and a database table. Input text fields included in the table are evaluated as eligible features to determine a performance metric corresponding to how well each input text field predicts the desired target field. In some embodiments, the evaluated fields provided by the user are ranked and included among the ranked eligible fields are text input fields. As with other eligible features, text input fields are evaluated to determine the feature's impact score. In some embodiments, the impact score can be calculated as a relief score. For example, in some embodiments, the relief score is a weighted and normalized relief score. Multiple weighted and normalized relief scores can be calculated for the same eligible feature, and an averaged impact score can be used.

In some embodiments, the determined impact score is used to predict a performance metric. The performance metric prediction can be determined by applying a machine learning model trained offline. For example, using the relief score and a text field density score, a machine learning model can predict a performance metric for a text input field. In some embodiments, the performance metric is based on the expected increase in the model's area under the precision-recall curve (AUPRC). The applied model translates an impact score to a performance metric by evaluating feature selection for a large cross section of machine learning problems. This training for the model can be performed offline in advance of evaluating the eligible features. By utilizing a model trained offline, a performance metric for an eligible feature can be quickly determined using the determined impact score of the feature. In various embodiments, while at least one input to the trained model is the text input field's impact score, additional inputs, such as the field's text field density, can be appropriate as well to improve the accuracy of the performance metric prediction. In various embodiments, the predicted performance metric can be used to rank and recommend eligible features of the user's provided dataset.

In some embodiments, a pre-trained model is generated to predict a measure of expected model performance based at least in part on a feature relevance score associated with a text field data type. For example, a model can be trained offline by evaluating feature selection for a large cross section of machine learning problems. In particular, the model is trained to predict a performance score or metric of a feature that has a text field data type. Using a feature relevance score such as an impact score, the model can predict the eligible feature's expected model performance. For example, the performance can be provided in terms of the feature's expected improvement in the model's area under the precision-recall curve (AUPRC). In some embodiments, a specification of a desired target field for machine learning prediction and one or more text fields storing input content is received. For example, a user specifies a desired target field such as a field from a customer database table. The user also specifies additional fields such as one or more text fields from the same database table or other database tables. The additional fields are eligible features that may be useful for predicting a result for the desired target field. The eligible features can be specified by the user for evaluation to determine which of the eligible features should be recommended for predicting the desired target field. In some embodiments, a corresponding feature relevance score is calculated for each of the one or more text fields storing the input content. For example, an impact score is calculated for each eligible text field feature. The impact score can be a relief score such as a normalized, weighted, and averaged relief score. In some embodiments, based on the corresponding calculated feature relevance scores, a corresponding measure of expected model performance for each of the one or more text fields storing the input content is predicted using the pre-trained model. For example, using the pre-trained model, an expected model performance is inferred for each of the one or more text field features using the calculated impact/relevance scores. In some embodiments, the expected model performance is a performance metric such as the expected improvement in the model's area under the precision-recall curve (AUPRC). The predicted measures of expected model performance are provided for use in feature selection among the one or more text fields storing the input content for generating a machine learning model to predict the desired target field. For example, the predicted performance metrics can be used to recommend which text field features should be utilized for creating a machine learning model to predict the desired target field. In some embodiments, the text field features are ranked by performance metric and only the features that meet a performance threshold may be recommended. A user can select from the recommended text field features among other eligible and ranked non-text field features to generate a machine learning model to predict the desired target field.

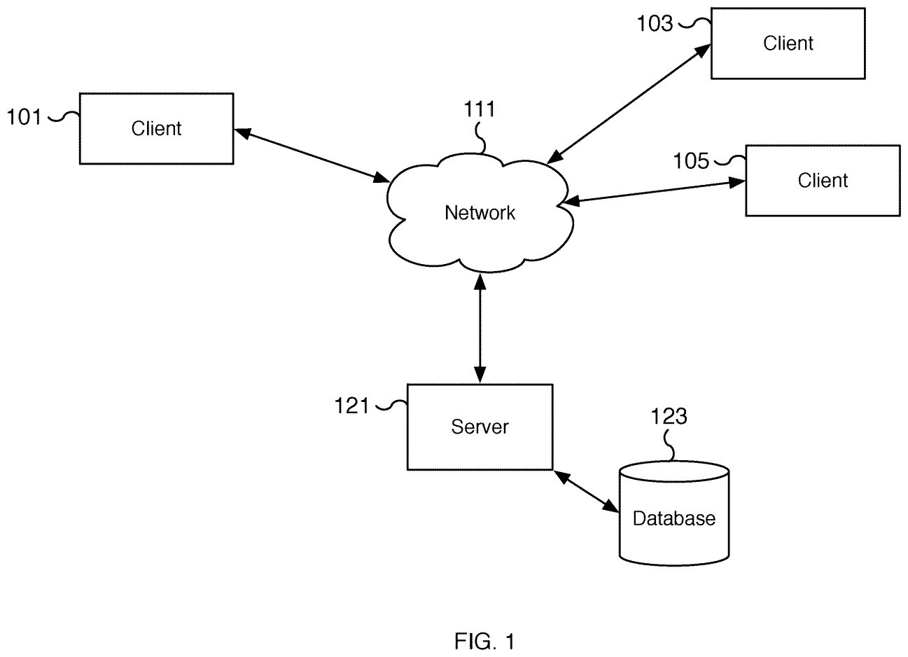

FIG. 1 is a block diagram illustrating an example of a network environment for creating and utilizing a machine learning model. In the example shown, clients 101, 103, and 105 access services on server 121 via network 111. The services include prediction services that utilize machine learning. For example, the services can include both the ability to generate a machine learning model using recommended features as well as the services for applying the generated model to predict results such as classification results. Network 111 can be a public or private network. In some embodiments, network 111 is a public network such as the Internet. In various embodiments, clients 101, 103, and 105 are network clients such as web browsers for accessing services provided by server 121. In some embodiments, server 121 provides services including web applications for utilizing a machine learning platform. Server 121 may be one or more servers including servers for identifying recommended features for training a machine learning model. Server 121 may utilize database 123 to provide certain services and/or for storing data associated with the user. For example, database 123 can be a configuration management database (CMDB) used by server 121 for providing customer services and storing customer data. In some embodiments, database 123 stores customer data related to customer tasks, incidents, and cases, etc. Database 123 can also be used to store information related to feature selection for training a machine learning model. In some embodiments, database 123 can store customer configuration information related to managed assets, such as related hardware and/or software configurations.

In some embodiments, each of clients 101, 103, and 105 can access server 121 to create a custom machine learning model. For example, clients 101, 103, and 105 may represent one or more different customers that each want to create a machine learning model that can be applied to predict results. In some embodiments, server 121 supplies to a client, such as clients 101, 103, and 105, an interactive tool for selecting and/or confirming feature selection for training a machine learning model. For example, a customer of a software-as-a-service platform provides via a client, such as clients 101, 103, and 105, relevant training data such as customer data to server 121 as training data. The provided customer data can be data stored in one or more tables of database 123. Along with the provided training data, the customer selects a desired target field, such as one of the table columns of the provided tables. Using the provided data and desired target field, server 121 recommends a set of features that predict with a high degree of accuracy the desired target field. A customer can select a subset of the recommended features from which to train a machine learning model. In some embodiments, the model is trained using the provided customer data. In some embodiments, as part of the feature selection process, the customer is provided with a performance metric of each recommended feature. The performance metric provides the customer with a quantified value related to how much a specific feature improves the prediction accuracy of a model. In some embodiments, the recommended features are ranked based on impact on prediction accuracy.

In some embodiments, a trained machine learning model is incorporated into an application to infer the desired target field. For example, an application can receive an incoming report of a support incident event and predict a category for the incident and/or assign the reported incident event to a responsible party. The support incident application can be hosted by server 121 and accessed by clients such as clients 101, 103, and 105. In some embodiments, each of clients 101, 103, and 105 can be a network client running on one of many different computing devices, including laptops, desktops, mobile devices, tablets, kiosks, smart televisions, etc.

Although single instances of some components have been shown to simplify the diagram, additional instances of any of the components shown in FIG. 1 may exist. For example, server 121 may include one or more servers. Some servers of server 121 may be web application servers, training servers, and/or interference servers. As shown in FIG. 1, the servers are simplified as single server 121. Similarly, database 123 may not be directly connected to server 121, may be more than one database, and/or may be replicated or distributed across multiple components. For example, database 123 may include one or more different servers for each customer. As another example, clients 101, 103, and 105 are just a few examples of potential clients to server 121. Fewer or more clients can connect to server 121. In some embodiments, components not shown in FIG. 1 may also exist.

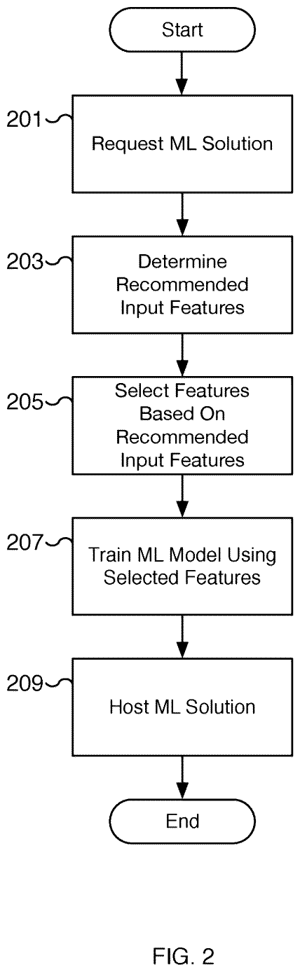

FIG. 2 is a flow chart illustrating an embodiment of a process for creating a machine learning solution. For example, using the process of FIG. 2, a user can request a machine learning solution to a problem. The user can identify a desired target field for prediction and provide a reference to data that can be used as training data. The provided data is analyzed and input features are recommended for training a machine learning model. The recommended features are provided to the user and a machine learning model can be trained based on the features selected by the user. The trained model is incorporated into a machine learning solution to predict the user's desired target field. In some embodiments, the machine learning platform for creating the machine learning solution is hosted as a software-as-a-service web application. In some embodiments, a user requests the solution via a client such as clients 101, 103, and/or 105 of FIG. 1. In some embodiments, the machine learning platform including the created machine learning solution is hosted on server 121 of FIG. 1.

At 201, a machine learning solution is requested. For example, a customer may want to automatically predict a responsible party for incoming support incident event reports using a machine learning solution. In some embodiments, the user requests a machine learning solution via a web application. In requesting the solution, the user can specify the target field the user wants predicted and provide related training data. In some embodiments, the provided training data is historical customer data. The customer data can be stored in a customer database. In some embodiments, the user provides one or more database tables as training data. The database tables can also include the desired target fields. In some embodiments, the user specifies multiple target fields. In the event prediction for multiple fields is desired, the user can specify multiple fields together and/or request multiple different machine learning solutions. In some embodiments, the user also specifies other properties of the machine learning solution such as a processing language, stop words, filters for the provided data, and a desired model name and description, among others.

At 203, recommended input features are determined. For example, a set of eligible machine learning features based on the requested machine learning solution are determined. From the eligible features, a set of recommended features are identified. In some embodiments, the recommended features are identified by evaluating the eligible machine learning features using a pipeline of different evaluations. At each stage of the pipeline, one or more of the eligible machine learning features can be successively filtered out. At the end of the pipeline, a set of recommended features are identified. In some embodiments, the identification of the recommended features includes determining one or more metrics associated with a feature such as an impact score or performance metric. For example, a model trained offline can be applied to each feature to determine a performance metric quantifying how much the feature will increase the area under a precision-recall curve (AUPRC) of a model trained with the feature. In some embodiments, an appropriate threshold value can be utilized for each metric to determine whether a feature is recommended for use in training.

In some embodiments, the eligible machine learning features are based on input data provided by a user. For example, in some embodiments, a user provides one or more database tables or another appropriate data structure as training data. In the event database tables are provided, the eligible machine learning features can be based on the columns of the tables. In some embodiments, the data type of each column is determined and columns with nominal data types are identified as eligible features. In some embodiments, data from certain columns can be excluded if the column data is unlikely to help with prediction. For example, columns can be removed based on how sparsely populated the data is, the occurrence of stop words, the relative distribution of different values for a column, etc.

At 205, features are selected based on the recommended input features. For example, using an interactive user interface, a set of recommended machine learning features for use in building a machine learning model are presented to a user. In some embodiments, the example user interface is implemented as a web application or web service. A user can select from the displayed recommended features to determine the set of features to use for training the machine learning model. In some embodiments, the recommended input features determined at 203 are automatically selected as the default features for training. No user input may be required for selecting the recommended input features. In some embodiments, the recommended input features can be presented in ranked order based on how each impacts the prediction accuracy of a model. For example, the most relevant input feature is ranked first. In various embodiments, the recommended features are displayed along with an impact score and/or performance metric. For example, an impact score can measure how much impact the feature has on model accuracy. A performance metric can quantify how much a model will improve in the event the feature is used for training. For example, in some embodiments, the performance metric displayed is based on the amount of increase in the area under a precision-recall curve (AUPRC) of the machine learning model when using the feature. Other performance metrics can be used as appropriate. By ranking and quantifying the different features, a user with little to any subject matter expertise can easily select the appropriate input features to train a highly accurate model.

At 207, a machine learning model is trained using the selected features. For example, using the features selected at 205, a training data set is prepared and used to train a machine learning model. The model predicts the desired target field specified at 201. In some embodiments, the training data is based on customer data received at 201. The customer data may be stripped of data not useful for training, such as data from table columns corresponding to features not selected at 205. For example, data corresponding to columns associated with features that are identified to have little to no impact on the accuracy of the prediction is excluded from the dataset used for training the machine learning model.

At 209, the machine learning solution is hosted. For example, an application server and machine learning platform host a service to apply the trained machine learning model to input data. For example, a web service applies the trained model to automatically categorize incoming incident reports. The categorization can include identifying the type of incident and a responsible party. Once categorized, the hosted solution can assign and route the incident to the predicted responsible party. In some embodiments, the hosted application is a custom machine learning solution for a customer of a software-as-a-service platform. In some embodiments, the solution is hosted on server 121 of FIG. 1.

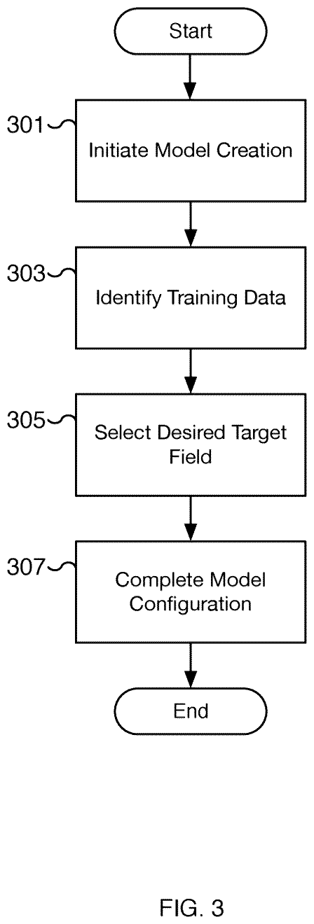

FIG. 3 is a flow chart illustrating an embodiment of a process for automatically identifying recommended features for a machine learning model. Using the process of FIG. 3, a user can automate the creation of a machine learning model by utilizing recommended features identified from potential training data. The user specifies a desired target field and supplies potential training data. The machine learning platform identifies recommended fields from the supplied data for creating a machine learning model to predict the desired target field. In some embodiments, the process of FIG. 3 is performed at 201 of FIG. 2. In some embodiments, the process of FIG. 3 is performed on a machine learning platform at server 121 of FIG. 1.

At 301, model creation is initiated. For example, a customer initiates the creation of a machine learning model via a web service application. In some embodiments, the customer initiates the model creation by accessing a model creation webpage via a software-as-a-service platform for creating automated workflows. The service may be part of a larger machine learning platform that allows the user to incorporate a trained model to predict outcomes. In some embodiments, the predicted outcomes can be used to automate a workflow process, such as routing incident reports to an assigned party once the appropriate party is automatically predicted using the trained model.

At 303, training data is identified. For example, a user designates data as potential training data. In some embodiments, the user points to one or more database tables from a customer database or another appropriate data structure storing potential training data. The data can be historical customer data. For example, the historical customer data can include incoming incident reports and their assigned responsible parties as stored in one or more database tables. In some embodiments, the identified training data includes a large number of potential input features and may not be properly prepared as high quality training data. For example, certain columns of data may be sparsely populated or only contain the same constant value. As another example, the data types of the columns may be improperly configured. For example, nominal or numeric data values may be stored as a text in the identified database table. In various embodiments, the identified training data needs to be prepared before it can be efficiently used as training data. For example, data from one or more columns that have little to no impact on model prediction accuracy is removed.

At 305, a desired target field is selected. For example, a user designates a desired target field for machine learning prediction. In some embodiments, the user selects a column field from the data identified at 303. For example, a user can select a category type for an incident report to express the user's desire to create a machine learning model to predict the category type of an incoming incident report. In some embodiments, the user can select from the potential input features of the training data provided at 303. In some embodiments, the user selects multiple desired target fields that are predicted together.

At 307, model configuration is completed. For example, the user can provide additional configuration options such as a model name and description. In some embodiments, the user can specify optional stop words. For example, stop words can be supplied to prepare the training data. In some embodiments, the stop words are removed from the provided data. In some embodiments, a user can specify a processing language and/or additional filters for the provided data. For example, stop words for the specified language can be added by default or suggested. With respect to specified additional filters, conditional filters can be applied to create a represented dataset from the training data identified at 303. In some embodiments, rows of the provided tables can be removed from the training data by applying one or more specified conditional filters. For example, a table can contain a “State” column with the possible values: “New,” “In Progress,” “On Hold,” and “Resolved.” A condition can be specified to only utilize as training data the rows where the “State” field has the value “Resolved.” As another example, a condition can be specified to only utilize as training data rows created after a specified date or time frame.

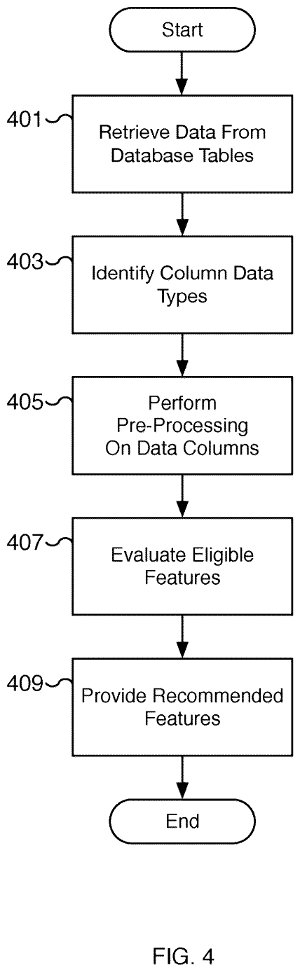

FIG. 4 is a flow chart illustrating an embodiment of a process for automatically identifying recommended features for a machine learning model. For example, using the feature selection pipeline of FIG. 4, eligible features of a dataset can be evaluated in real-time to determine how each potential feature would impact a machine learning model for predicting a desired target field. In various embodiments, a set of recommended features is determined and can be selected from to train a machine learning model. The recommended features are selected based on their accuracy in predicting the desired target field. For example, useless features are not recommended. In some embodiments, the process of FIG. 4 is performed at 203 of FIG. 2. In some embodiments, the process of FIG. 4 is performed on a machine learning platform at server 121 of FIG. 1.

At 401, data is retrieved from database tables. For example, a potential training dataset stored in one or more identified database tables is identified by a user and the associated data is retrieved. In some embodiments, conditional filters are applied to the associated data before (or after) the data is retrieved. For example, only certain rows of the database table may be retrieved based on conditional filters. As another example, stop words are removed from the retrieved data. In some embodiments, the data is retrieved from identified tables to a machine learning training server.

At 403, column data types are identified. For example, the data type of each column of data is identified. In some embodiments, the column data types as configured in the database table are not specific enough to be used for evaluating the associated feature. For example, nominal values can be stored as text or binary large object (BLOB) values in a database table. As another example, numeric or date types can also be stored as text (or string) data types. In various embodiments, at 403, the column data types are automatically identified without user intervention.

In some embodiments, the data types are identified by first scanning through all the different values of a column and analyzing the scanned results. The properties of the column can be utilized to determine the effective data type of the column values. For example, text data can be identified at least in part by the number of spaces and the amount of text length variation in a column field. As another example, in the event there is little or no variation in the actual values stored in a column field, the column data type may be determined to be a nominal data type. For example, a column with five discrete values but stored as string values can be identified as a nominal type. In some embodiments, the distribution of value types is used as a factor in identifying data type. For example, if a high percentage of the values in a column are numbers, then the column may be classified as a numeric data type.

At 405, pre-processing is performed on the data columns. In some embodiments, a set of pre-processing rules are applied to remove useless columns. For example, columns with sparsely populated fields are removed. In some embodiments, a threshold value is utilized to determine if a column is sparsely populated and a candidate for removal. For example, in some embodiments, a threshold value of 20% is used. A column where less than 20% of the data is populated is an unnecessary column and can be removed. As another example, columns where all values are a constant are removed. In some embodiments, columns where one value dominates the other values, for example, a dominant value appears in more than 80% (or another threshold amount) of records, are removed. Columns where every value is unique or is an ID may be removed as well. In some embodiments, non-nominal columns are removed. For example, columns with binary data or text strings can be removed. In various embodiments, the pre-processing step eliminates only a subset of all eligible features from consideration as recommended input features.

At 407, eligible machine learning features are evaluated. For example, the eligible machine learning features are evaluated for impact on training an accurate machine learning model. In some embodiments, the eligible machine learning features are evaluated using an evaluation pipeline to successively filter out features by usefulness in predicting the desired target value. For example, in some embodiments, a first evaluation step can determine an impact score such as a relief score to identify the distinction a column brings to a classification model. Columns with a relief score below a threshold value can be removed from recommendation. As another example, in some embodiments, a second evaluation step can determine an impact score such as an information gain or weighted information gain for a column. Using a selected feature and the desired target field, an impact score can be determined by comparing the improvement of the feature by using changes in information entropy when considering a feature. Columns with an information gain or weighted information gain score below a threshold value can be removed from recommendation. In some embodiments, a third evaluation set can determine a performance metric for each feature. For example, a model is created offline to convert an impact score, such as an information gain or weighted information gain score, to a performance metric such as one based on an increase to the area under a precision-recall curve (AUPRC) for a model. In various embodiments, the trained model is applied to an impact score to determine an AUPRC-based performance metric for each remaining eligible feature. Using the determined performance metrics, columns with a performance metric below a threshold value can be removed from recommendation. Although three evaluation steps are described above, fewer or additional steps may be utilized, as appropriate, based on the desired outcome for the set of recommended features. For example, one or more different evaluation techniques can be applied in addition to or to replace the described evaluation steps to further reduce the number of eligible features.

In various embodiments, by applying successive evaluation steps, the set of recommended machine learning features for building a machine learning model is identified. In some embodiments, the successive evaluation steps are necessary to determine which features result in an accurate model. Any one evaluation step alone may be insufficient and could incorrectly identify for recommendation a poor feature for training. For example, a feature can have a high relief score but a low weighted information gain score. The low weighted information gain score indicates that the feature should not be used for training. In some embodiments, a key or similar identifier column is a poor feature for training since it has little predictive value. The column can have a high impact score when evaluated under one of the evaluation steps but will be filtered from being recommended by a successive evaluation step.

At 409, recommended features are provided. For example, the remaining features are recommended as input features. In some embodiments, the set of recommended features is provided to the user via a graphical user interface of a web application. The recommended features can be provided with quantified metrics related to how much impact each of the features has on model accuracy. In some embodiments, the features are provided in a ranked order allowing a user to select the most impactful features for training a machine learning model.

In some embodiments, useless features are also provided along with the recommended features. For example, a user is provided with a set of features that are identified as useless or having minor impact to model accuracy. This information can be helpful for the user to gain a better understanding of the machine learning problem and solution.

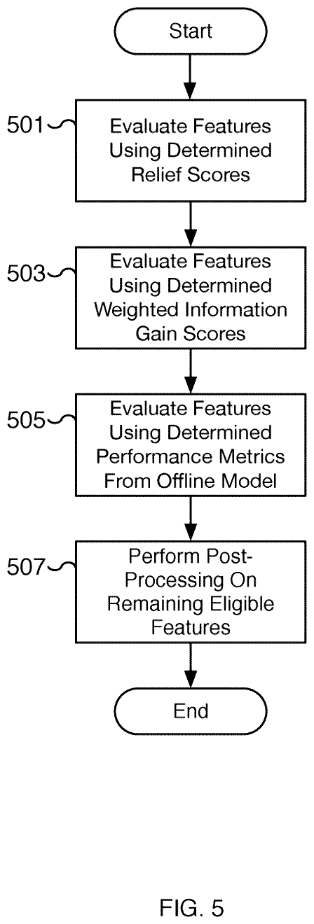

FIG. 5 is a flow chart illustrating an embodiment of an evaluation process for automatically identifying recommended features for a machine learning model. In some embodiments, the evaluation process is a multistep process to successively filter out features from the eligible machine learning features to identify a set of recommended machine learning features. The process utilizes data provided as potential training data from which the eligible machine learning features are identified and can be performed in real-time. Although described with specific evaluation steps with respect to FIG. 5, alternative embodiments of an evaluation process can utilize fewer or more evaluation steps and may incorporate different evaluation techniques. In some embodiments, the process of FIG. 5 is performed at 203 of FIG. 2 and/or at 407 of FIG. 4. In some embodiments, the process of FIG. 5 is performed on a machine learning platform at server 121 of FIG. 1.

At 501, features are evaluated using determined relief scores. In various embodiments, an impact score using a relief-based technique is determined at 501 and used to filter one or more eligible machine learning features to identify a set of recommended machine learning features. For example, an impact score based on a relief score for each feature is determined. Columns with a relief score below a threshold value can be removed from recommendation. In some embodiments, a relief score corresponds to the impact a column has in differentiating different classification results. In various embodiments, for each feature, multiple neighboring rows are selected. The rows are selected based on having values that are similar (or values that are mathematically close or nearby) with the exception of the values for the column currently being evaluated. For example, for a table with three columns A, B and C, column A is evaluated by selecting rows with similar values for corresponding columns B and C (i.e., the values for column B are similar for all selected rows and the values for column C are similar for all selected rows). This impact score will utilize the selected rows to determine how much column A impacts the desired target field. In the example, the target field can correspond to one of columns B or C. Using the selected neighboring rows, an impact or relief score is calculated for each eligible feature. The scores may be normalized and compared to a threshold value. A feature with a relief score that falls below the threshold value is identified as a useless column and can be excluded from further consideration as a recommended input feature. A feature with a relief score that meets the threshold value will be further evaluated for consideration as a recommended input feature at 503. In some embodiments, the eligible features are ranked by the determined relief score and a feature may be removed from consideration as a recommended input feature if the feature does not rank high enough. For example, in some embodiments, only a maximum number of features based on ranking (such as the top ten or top 10% of eligible features) is retained for further evaluation at 503.

At 503, features are evaluated using weighted information scores. In various embodiments, an impact score using an information gain technique is determined at 503 and used to filter one or more eligible machine learning features to identify a set of recommended machine learning features. For example, an impact score based on a weighted information gain score for each feature is determined. The columns with a weighted information gain score below a threshold value can be removed from recommendation. In some embodiments, a weighted information gain score of a feature corresponds to the change in information entropy when the value of the feature is known. The weighted information gain score is an information gain metric, which is weighted by the target distribution of different known values for the feature. In some embodiments, the weightages are proportional to the frequency of a given target value. In some embodiments, a non-weighted information score may be used as an alternative impact score.

In various embodiments, the eligible features are ranked by the determined weighted information gain score and a feature may be removed from consideration as a recommended input feature if the feature does not rank high enough. For example, in some embodiments, only a maximum number of features based on ranking (such as the top ten or top 10% of eligible features) is retained for further evaluation at 505.

At 505, performance metrics are determined for features. In various embodiments, a performance metric is determined for each of the remaining eligible features using the corresponding impact score of the feature determined at 503. The performance metric is used to filter one or more eligible machine learning features to identify a set of recommended machine learning features. For example, a weighted information gain score (or for some embodiments, a non-weighted information gain score) is converted to a performance metric, for example, by applying a model that has been created offline. In some embodiments, the model is a regression model and/or a trained machine learning model for predicting an increase in the area under a precision-recall curve (AUPRC) as a function of a weighted information gain score. In various embodiments, the offline model is applied to the impact score from step 503 to infer a performance metric such as an AUPRC-based performance metric for a model when utilizing the feature being evaluated. The AUPRC-based performance metrics determined for each of the remaining eligible features can be used to rank the remaining features and filter out those that do not meet a certain threshold or fall within a certain threshold range. In some embodiments, the eligible features are ranked by the determined AUPRC-based performance metric and a feature may be removed from consideration as a recommended input feature if the feature does not rank high enough. For example, in some embodiments, only a maximum number of features based on ranking (such as the top ten or top 10% of eligible features) is retained for post-processing at 507.

In some embodiments, the accurate determination of a performance metric such as an AUPRC-based performance metric can be time-consuming and resource intensive. By utilizing a model prepared offline (such as a conversion model) to determine a performance metric from a weighted information gain score, the performance metric can be determined in real-time. Time and resource intensive tasks are shifted from the process of FIG. 5 and in particular from step 505 to the creation of the conversion model, which can be pre-computed and applied to multiple machine learning problems. For example, once the conversion model is created, the model can be applied across multiple machine learning problems and for multiple different customers and datasets.

At 507, post-processing is performed on eligible features. For example, the remaining eligible features are processed for consideration as recommended machine learning features. In some embodiments, the post-processing performed at 507 includes a final filtering of the remaining eligible features. The post-processing step may be utilized to determine a final ranking of the remaining eligible features based on predicted model performance. In some embodiments, the final ranking is based on the performance metrics determined at 505. For example, the feature with the highest expected improvement is ranked first based on its performance metric. In various embodiments, features that do not meet a final threshold value or fall outside of a final threshold range or ordered ranking can be removed from recommendation. In some embodiments, none of the remaining eligible features meet the final threshold value for recommendation. For example, even the top-ranking feature does not significantly improve prediction accuracy over a naïve model. In this scenario, none of the remaining eligible features may be recommended. In various embodiments, the remaining eligible features after a final filtering are the set of recommended machine learning features and each includes a performance metric and associated ranking. In some embodiments, a set of non-recommended features is also created. For example, any feature that is determined to not significantly improve model prediction accuracy based on the evaluation process is identified as useless.

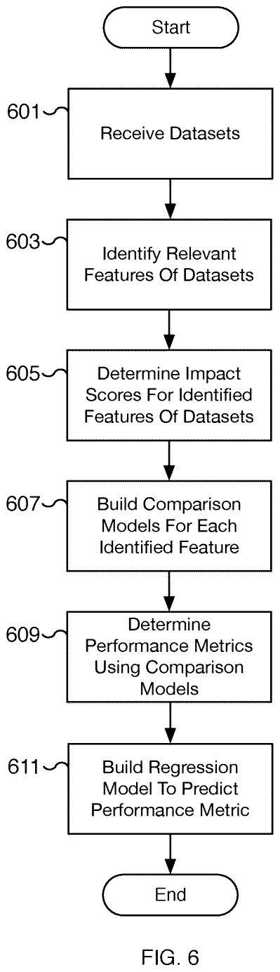

FIG. 6 is a flow chart illustrating an embodiment of a process for creating an offline model for determining a performance metric of a feature. Using the process of FIG. 6, an offline model is created to convert an impact score of a feature to a performance metric. For example, a weighted information gain score (or for some embodiments, a non-weighted information gain score) is used to predict an increase in the area under a precision-recall curve (AUPRC) performance metric. The performance metric can be utilized to evaluate the expected improvement a feature has in improving the accuracy of model prediction. In various embodiments, the model is created as part of an offline process and applied during a real-time process for feature recommendation. In some embodiments, the offline model created is a machine learning model. In some embodiments, the offline model created using the process of FIG. 6 is utilized at 203 of FIG. 2, at 407 of FIG. 4, and/or at 505 of FIG. 5. In some embodiments, the model is created on a machine learning platform at server 121 of FIG. 1.

At 601, datasets are received. For example, multiple datasets are received for building the offline model. In some embodiments, hundreds of datasets are utilized to build an accurate offline model. The datasets received can be customer datasets stored in one or more database tables.

At 603, relevant features of the datasets are identified. For example, columns of the received datasets are processed for relevant features and features corresponding to the non-relevant columns of the datasets are removed. In some embodiments, the data is pre-processed to identify column data types and non-nominal columns are filtered out to identify relevant features. In various embodiments, only the relevant features are utilized for training the offline model. In some embodiments, text field input columns are identified among the received datasets. For example, a database table can include one or more text field input fields that contain text input of variable or arbitrary lengths. The fields are identified as potential eligible features for predicting a desired target field and are evaluated as text field input features and not nominal types.

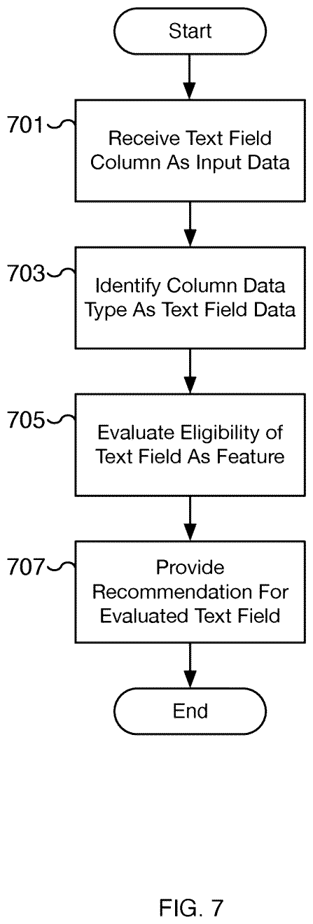

At 605, impact scores are determined for the identified features of the datasets. For example, an impact score is determined for each of identified features. In some embodiments, the impact score is a weighted information gain score. In some embodiments, a non-weighted information gain score is used as an alternative impact score. In determining an impact score, a pair of identified features can be selected with one as the input and the other as the target. The impact score can be computed using the selected pair to compute a weighted information gain score. Weighted information gain scores can be determined for each of the identified features of each dataset. In some embodiments, the impact score is determined using the techniques described with respect to step 503 of FIG. 5. In some embodiments, the impact score is an averaged weighted score. For example, the impact score can be determined for text field input features using the techniques described with respect to the processes of FIGS. 7-10.

At 607, comparison models are built for each identified feature. For example, a machine learning model is trained using each identified feature and a corresponding model is created as a baseline model. In some embodiments, the baseline model is a naïve model. For example, the baseline model can be a naïve probability-based classifier. In some embodiments, the baseline model may predict a result by always predicting the most likely outcome, by randomly selecting an outcome, or by using another appropriate naïve classification technique. The trained model and the baseline model together are comparison models for an identified feature. The trained model is a machine learning model that utilizes the identified feature for prediction and the baseline model represents a model where the feature is not utilized for prediction.

At 609, performance metrics are determined using the comparison models. By comparing the prediction results and accuracy of the two comparison models for each identified feature, a performance metric can be determined for the feature. For example, for each identified feature, the area under the precision-recall curve (AUPRC) can be evaluated for the trained model and the baseline model. In some embodiments, the difference between the two AUPRC results is the performance metric of the feature. For example, the performance metric of a feature can be expressed as the increase in AUPRC between the comparison models. For each identified feature, the performance metric is associated with the impact score. For example, an increase in AUPRC is associated with a weighted information gain score.

At 611, a regression model is built to predict the performance metric. Using the impact score and performance metric pairs determined at 605 and 609 respectively, a regression model is created to predict a performance metric from an impact score. For example, a regression model is created to predict a feature's increase in the area under the precision-recall curve (AUPRC) as a function of the feature's weighted information gain score. In some embodiments, the regression model is a machine learning model trained using the impact score and performance metric pairs determined at 605 and 609 as training data. In various embodiments, the trained model can be applied in real time to predict a performance metric of a feature once an impact score is determined. For example, the trained model can be applied at step 505 of FIG. 5 to determine a feature's performance metric for evaluating the expected improvement in model quality associated with a feature.

FIG. 7 is a flow chart illustrating an embodiment of a process for automatically identifying and evaluating text fields as potential features for a machine learning model. For example, using the process of FIG. 7, a text field can be evaluated to determine an expected model performance if the text field is utilized as an input feature for predicting a desired target field. In some embodiments, the process of FIG. 7 can be initiated by the process of FIG. 3. For example, using the process of FIG. 3, a user can automate the creation of a machine learning model for predicting a desired target field by utilizing recommended text field features identified from potential training data. The identified text fields are processed and evaluated for recommendation as features using the process of FIG. 7. The text fields are evaluated as variable and/or arbitrary length text fields rather than being converted to a nominal type and evaluated as a nominal type. Similarly, in some embodiments, the feature selection pipeline of FIG. 4 relies on the process of FIG. 7 to evaluate in real-time how a potential text field feature would impact a machine learning model for predicting a desired target field. In some embodiments, the text field evaluated using the process of FIG. 7 is identified as potential training data at step 303 of FIG. 3. In some embodiments, the various steps of the process of FIG. 7 are performed by the process of FIG. 4. For example, in some embodiments, step 701 is performed at 401 of FIG. 4, step 703 is performed at 403 of FIG. 4, step 705 is performed at 405 and/or 407 of FIG. 4, and/or step 707 is performed at 409 of FIG. 4. In some embodiments, the process of FIG. 7 is performed on a machine learning platform at server 121 of FIG. 1 and/or at 203 of FIG. 2 to at least in part determine recommended input features.

At 701, a text field column is received as input data. For example, a text field column of a database table or dataset is identified by a user as potential training data. Once identified, the text field column is received as input data that can be evaluated. In some embodiments, the text field column includes entries corresponding to variable or arbitrary length text.

At 703, the column data type for the received text field column is identified as text field data. For example, entries of the received text field column are evaluated to determine that the column data type is text field data. This evaluation step can be necessary to determine that the data type of the received text field column is actually text data and not another type such as a nominal type compatible with text data. For example, in some scenarios, data stored in the text field column is stored as text data but another data type such as a nominal, integer, numeric, or another appropriate data type can more accurately and/or efficiently describe the data. At 703, the column data type for the received text field column is confirmed to be text field data.

At 705, the eligibility of the text field as a feature is evaluated. For example, the text field column is evaluated as an eligible feature for predicting a desired target field. In some embodiments, the text field is first evaluated to determine a feature relevance score such as an impact score in predicting the desired target field. An example impact score can be a computed as a weighted and normalized relief score. In some embodiments, the relief score is a ReliefFscore that is a statistical measure that indicates the feature relevance according to how well feature values distinguish the target among instances that are similar to each other. A Euclidean norm/Frobenius norm of ReliefFscore can be calculated from the text features dimensions and normalized using the distribution of the target feature to derive the weighted and normalized relief score. Using the computed feature relevance score, a performance metric can be determined. For example, a corresponding measure of expected model performance can be predicted by applying a pre-trained model to the computed impact score. In some embodiments, other metrics of the text data are evaluated as well, such as text field density, and utilized in the prediction. In some embodiments, the performance metric corresponds to the text field's eligibility as a feature for predicting the desired target field. For example, the higher the predicted performance metric, the more eligible and/or more highly recommended the text field is as a feature for predicting the desired target field.

At 707, a recommendation is provided for the evaluated text field. For example, using the determined eligibility evaluation, a recommendation is made regarding the text field received at 701. In some embodiments, the recommendation includes ranking the evaluated text field among other potential features. As a useful guide to aid the user in selecting between different potential features, the recommendation can include the expected improvement in model performance when relying on the evaluated text field as an input feature. In some embodiments, a text field may only be recommended if the determined performance metric exceeds a minimum performance threshold. In various embodiments, a user can utilize the provided recommendation to select features for the automatic creation of a machine learning model to predict a desired target field.

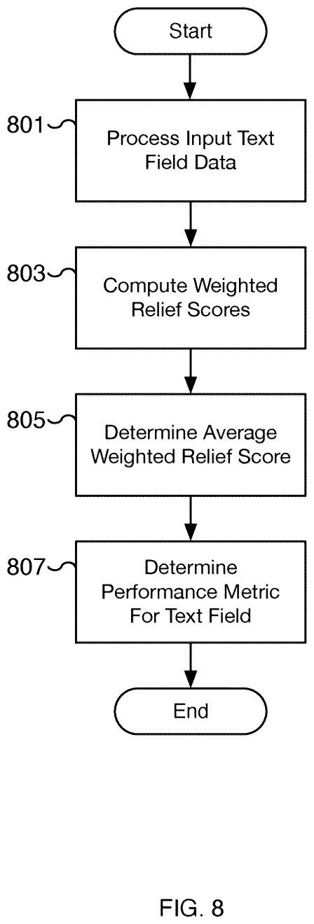

FIG. 8 is a flow chart illustrating an embodiment of a process for evaluating the eligibility of a text field as a feature for a machine learning model to predict a desired target field. In some embodiments, the process of FIG. 8 evaluates text field data provided as potential training data and can be performed in real-time. In some embodiments, the process of FIG. 8 is performed at 203 of FIG. 2, at 405 and/or 407 of FIG. 4, and/or at 705 of FIG. 7. In some embodiments, the various steps of the process of FIG. 8 are performed by the process of FIG. 5 when evaluating a text field. For example, in some embodiments, step 803 is performed at 501 of FIG. 5, step 805 is performed at 503 of FIG. 5, and/or step 807 is performed at 505 and/or 507 of FIG. 5. In some embodiments, the process of FIG. 8 is performed on a machine learning platform at server 121 of FIG. 1. In some embodiments, portions of the process of FIG. 8 are also utilized for training an offline performance metric prediction model. For example, in some embodiments, the impact score and other related metrics determined at 801, 803, and/or 805 are utilized at step 605 of FIG. 6 for training an offline performance metric prediction model. The pre-trained model is then utilized at 807 for determining the text field's corresponding performance metric.

At 801, input text field data is processed. For example, processing and/or pre-processing the text field data can be performed to prepare intermediary data required for computing an impact score. The processing can include determining statistical measurements on the text data as well as preparing multiple evaluation samples from the text data. In some embodiments, the processing includes determining term frequency-inverse document frequency (TF-IDF) metrics for the provided text data and/or performing a projection of the text data to reduce the number of dimensions. Other appropriate processing can be performed such as determining text field density. In various embodiments, the input text field data can correspond to entries of a text field column in a specified database table or dataset.

At 803, weighted relief scores are computed. For example, using the intermediary data prepared at 801, weighted relief scores are computed for the text field. In some embodiments, the weighted relief scores are normalized relief scores. Each computed weighted relief score can correspond to a stratified sample set of the input data. By computing weighted relief scores on multiple samples of the input data, the data can be appropriately sampled with minimal resource requirements compared to computing a weighted relief score on the entirety of the input text field data. For example, in some scenarios, three stratified samples are prepared at 801 and three weighted relief scores are computed at 803, one corresponding to each prepared sample.

At 805, an average weighted relief score is determined. For example, using the computed weighted relief scores from 803, an average weighted relief score is computed. The average weighted relief score can be a normalized relief score and can correspond to an impact score for the text field. In some embodiments, the magnitude of the impact score corresponds to how much impact the text field has in predicting the desired target field. Although the impact score expresses the relevance of the feature in predicting the desired target field, it may not quantify the improvement in model performance if the text field is utilized as an input feature for a machine learning model. In some embodiments, the determined average weighted relief score and any other appropriate text field metrics, such as text field density computed at 801, are utilized for training an offline performance metric prediction model.

At 807, a performance metric for the text field is determined. For example, using the determined average weighted relief score and any additional text field metrics, such as text field density, a performance metric can be predicted. In some embodiments, the performance metric is inferred by applying a pre-trained model, such as a model trained offline using the process of FIG. 6. By utilizing a pre-trained model, the measure of expected model performance can be determined in real-time. Significant computational and resource intensive operations are instead performed offline during the training of the performance metric prediction model. In various embodiments, the determined performance metric can correspond to the text field feature's increase in the area under the precision-recall curve (AUPRC). The increase can correspond to the difference between a trained model using a similar text field as a feature for prediction and a baseline model that utilizes an appropriate naïve classification technique such as always predicting the most likely outcome. The determined performance metric provides an indication of the increase in performance that can be expected for a trained model utilizing the text field feature compared to a machine learning model that does not. In some embodiments, the performance metric is utilized to determine a recommendation for the text field as a potential or eligible feature for predicting the desired target field.

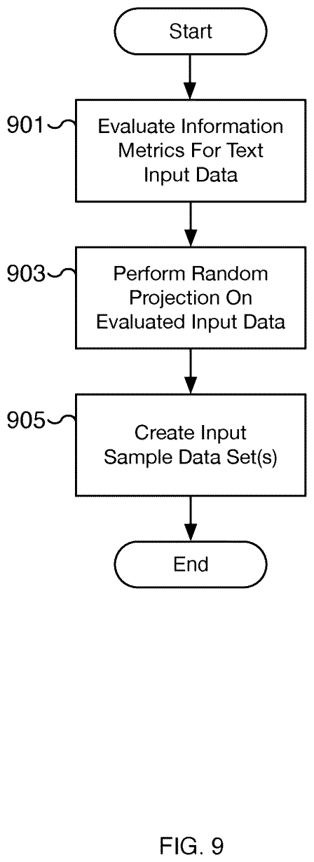

FIG. 9 is a flow chart illustrating an embodiment of a process for preparing input text field data to determine an impact score. In some embodiments, the process of FIG. 9 is performed at 405 of FIGS. 4 and/or 801 of FIG. 8 and precedes the calculation for determining the impact score or feature relevance of a text field on model performance. In some embodiments, the process of FIG. 9 is performed on a machine learning platform at server 121 of FIG. 1. In some embodiments, portions of the process of FIG. 9 are also utilized for training an offline performance metric prediction model. For example, in some embodiments, the process of FIG. 9 is performed along with additional steps to determine an impact score for a text field at step 605 of FIG. 6.

At 901, information metrics are evaluated for the text input data. For example, information metrics such as statistical measurements on the text input data are determined. The information metrics are computed in real-time and can include metrics such as term frequency-inverse document frequency (TF-IDF) metrics. As another example, an information metric such as text field density can be computed for the text input data. In some embodiments, the information metrics can be determined using a sample of the text input data or by evaluating the entire dataset of the text input data. In various embodiments, the text input data can correspond to entries of a text field column in a specified database table or dataset.

At 903, a random projection is performed on the evaluated input data. For example, for large datasets with a high number of dimensions, a random projection is performed to reduce the number of dimensions. In some embodiments, the number of dimensions can be reduced to a more efficient number such as 100 dimensions.

At 905, input sample data sets are created. For example, one or more samples of the text input data are created for evaluation. In some embodiments, the text input data is too large to efficiently compute a single impact score on the entire dataset. Instead, multiple sample data sets are created. Each can be scored for impact and then the sample impact scores are averaged. In various embodiments, stratified sampling is applied to create multiple sample data sets. The created data sets can include a sufficient sampling of the text input data. For example, in some embodiments, the created data sets cover approximately 10% of the text input data.

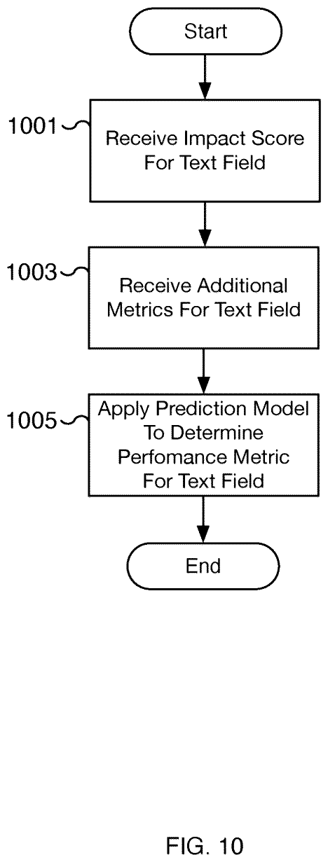

FIG. 10 is a flow chart illustrating an embodiment of a process for determining a performance metric for a text field feature. In some embodiments, the process of FIG. 10 is performed at 505 of FIG. 5, at 705 of FIG. 7, and/or at 807 of FIG. 8. In some embodiments, the impact score and additional informational metrics utilized by the process of FIG. 10 are computed using the processes of FIG. 8 and/or FIG. 9. In some embodiments, the process of FIG. 10 is performed on a machine learning platform at server 121 of FIG. 1.

At 1001, impact scores for a text field are received. For example, an impact score such as an average weighted relief score for a text field is received. The impact score can be a measure of feature relevance in predicting a desired target field when using the text field as a model feature. In some embodiments, the impact score received is calculated in real time and can be computed on one or more sample sets of the input text data of a text field. In various embodiments, the text field and its input text data can correspond to entries of a text field column in a specified database table or dataset.

At 1003, additional metrics for the text field are received. For example, additional metrics such as text field density are received and prepared for use as input features. In some embodiments, the use of additional metrics as input features for predicting performance metrics improves the prediction results compared to relying only on computed impact scores. In various embodiments, additional metrics can be calculated in real time and can be computed on either one or more sample sets of the input text data of a text field or on the entire text field dataset.

At 1005, a predication model is applied to determine a performance metric for the text field. For example, a performance metric prediction model is trained offline and applied at 1005 to predict a measure of expected model performance. In various embodiments, the input features for the prediction model include an impact score received at 1001 and one or more information metrics received at 1003. These received input features can be computed in real time along with the inferred performance metric. In contrast, the generation of the prediction model can be resource and computationally expensive, and benefits from being trained offline, for example, by using the process of FIG. 6. In some embodiments, the predicted performance metric corresponds to the text field feature's increase in the area under the precision-recall curve (AUPRC) when comparing two comparison models. For example, the metric can correspond to the performance difference between a trained model using a similar text field as a feature for prediction and a baseline model that utilizes an appropriate naïve classification technique such as always predicting the most likely outcome. The predicted performance metric provides an indication of the increase in performance that can be expected for a trained model utilizing the text field feature compared to a machine learning model that does not. In some embodiments, the performance metric is utilized to determine a recommendation for the text field as a potential or eligible feature for predicting the desired target field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
obtaining a plurality of feature relevance scores respectively associated with a plurality of data fields, wherein each of the plurality of feature relevance scores characterizes an extent to which a corresponding data field impacts a prediction of a target field, the target field to be generated by a first machine learning model;
generating, via a second machine learning model based on the plurality of feature relevance scores, respective associations between the target field and each of the plurality of data fields;
identifying a first data field of the plurality of data fields based on the respective associations; and
training the first machine learning model to predict the target field using a set of training data associated with the first data field.

2. The method of claim 1, comprising:
receiving an indication of:
the target field to be predicted by the first machine learning model; and
a dataset comprising the plurality of data fields, wherein the plurality of data fields comprises text fields.

3. The method of claim 2, wherein the text fields comprise variable length data entries that are not normalized prior to obtaining the plurality of feature relevance scores.

4. The method of claim 3, wherein the second machine learning model is a pretrained machine learning model.

5. The method of claim 2, comprising:
obtaining the feature relevance scores for the text fields by processing the text fields based on term frequency-inverse document frequency (TF-IDF) metrics, text field densities, evaluating samples of the text fields, or any combination thereof.

6. The method of claim 1, wherein the respective associations between the target field and each of the plurality of data fields are generated according to respective area under a precision-recall curves for each of the one or more feature relevance scores.

7. The method of claim 6, wherein the respective associations between the target field and each of the plurality of data fields are determined according to a comparison between the respective area under a precision-recall curves for each of the one or more feature relevance scores and a baseline model to predict the target field.

8. The method of claim 1, comprising:
converting the respective associations between the target field and each of the plurality of data fields to respective measures of expected performance of the first machine learning model in predicting the target field.

9. The method of claim 8, comprising:
ranking the respective measures of expected performance of the first machine learning model in predicting the target field;
identifying one or more data fields of the plurality of data fields based on the ranking of the respective measures of expected performance of the first machine learning model in predicting the target field; and
training the first machine learning model to predict the target field using additional training data associated with one or more data fields.

10. A system comprising:
processing circuitry; and
a memory accessible by the processing circuity, and storing instructions that, when executed by the processing circuitry, cause the processing circuitry to perform operations comprising:
obtaining a plurality of feature relevance scores respectively associated with a plurality of data fields, wherein each of the plurality of feature relevance scores characterizes an extent to which a corresponding data field impacts a prediction of a target field, the target field to be generated by a first machine learning model;
generating, via a second machine learning model based on the plurality of feature relevance scores, respective associations between the target field and each of the plurality of data fields;
identifying a first data field of the plurality of data fields based on the respective associations; and
training the first machine learning model to predict the target field using a set of training data associated with the first data field.

11. The system of claim 10, wherein the operations comprise:
receiving an indication of:
the target field to be predicted by the first machine learning model; and
a dataset comprising the plurality of data fields, wherein the plurality of data fields comprises text fields.

12. The system of claim 11, wherein the text fields comprise variable length data entries that are not normalized prior to obtaining the plurality of feature relevance scores.

13. The system of claim 12, wherein the operations comprise:
generating one or more sample datasets of each of the text fields;
determining the feature relevance score for each of the one or more sample datasets; and
averaging the feature relevance score for each of the one or more sample datasets to determine the feature relevance score for each of the text fields.

14. The system of claim 11, wherein the second machine learning model is a pretrained machine learning model.

15. A non-transitory, computer readable medium comprising instructions that, when executed by processing circuitry, cause the processing circuitry to perform operations comprising:
obtaining a plurality of feature relevance scores respectively associated with a plurality of data fields, wherein each of the plurality of feature relevance scores characterizes an extent to which a corresponding data field impacts a prediction of a target field, the target field to be generated by a first machine learning model;
generating, via a second machine learning model based on the plurality of feature relevance scores, respective associations between the target field and each of the plurality of data fields;
identifying a first data field of the plurality of data fields based on the respective associations; and
training the first machine learning model to predict the target field using a set of training data associated with the first data field.

16. The non-transitory computer readable medium of claim 15, wherein the operations comprise:
receiving an indication of:
the target field to be predicted by the first machine learning model; and
a dataset comprising the plurality of data fields, wherein the plurality of data fields comprises text fields.

17. The non-transitory computer readable medium of claim 16, wherein the operations comprise:
removing one or more rows from the dataset based on conditional filters.

18. The non-transitory computer readable medium of claim 15, wherein the feature relevance score for each of the data fields is a weighted and normalized relief score.

19. The non-transitory computer readable medium of claim 15, wherein the operations comprise:
receiving a report of a support incident event; and
predicting the target field based on the report.

20. The non-transitory computer readable medium of claim 15, wherein the operations comprise:
filtering one or more data fields associated with a feature relevance score below a threshold value.
